(19) United States
(12) Patent Application Publication
(10) Pub. No.: US 2002/0161616 A1
(43) Pub. Date: Oct. 31, 2002

(54) Computer based electronic-business planning system and method

(75) Inventors: Timothy Chi-Hong Chan, Quarry Bay (HK); Xavier Wing-Shing Ho, Hong Kong (HK)

Correspondence Address: David R. Irvin, IBM Corporation, T81/503, PO Box 12195, Research Triangle Park, NC, 27709, US

(73) Assignee: International Business Machines Corporation, Armonk, NY (US)

(21) Appl. No.: 10/128,562

(22) Filed: Apr. 23, 2002

(30) Foreign Application Priority Data
Apr. 28, 2001 (CN) 01117442.0

(51) Int. Cl. G06F 17/60

(52) U.S. Cl. 705/7

(57) ABSTRACT

A computer based e-business planning system and method enabling an entity to formulate an e-business strategy and implementation plan. The system and method direct the planner of the entity to make an e-business plan in eight aspects of e-business by completely considering the technology and business, the internal and external environment of the entity. Furthermore, the system and method direct the planner to make an effective action plan in the aspects of “implications”, “execution strategy”, “entry point”, “activities”, and “target state” step by step. In addition, the invention directs the planner flexibly to adjust the plan as needed.

### FIELD OF THE INVENTION

The invention relates to (e-business); and particularly, to a system and method for formulating an e-business plan when establishing an e-business.

### BACKGROUND

As the Internet has been rapidly developing, more and more entities have entered or are entering the e-business field. However, in the process of formulating a general plan of e-business, the internal and external environments of the entity are not sufficiently considered, as the only objective is to replicate an earlier business operation on an e-business platform. As a result, the full efficiency and effectiveness of e-business is unrealized. Conversely, for an entity which is going to enter the e-business field, formulating an all encompassing e-business plan in consideration with its internal and outside environments is necessary for the entity to execute the e-business successfully.

Now, there are two kinds of methods for directing a planner to make an e-business plan. One of these is the GANTT chart approach, which captures the plan schedule and resource utilization, so that the planner can clearly tell the progress and next steps from the chart. However, GANTT charts cannot display the effects attained by executing the plan and the resource requirements before executing a plan, so that a specific solution must be further determined when executing a plan in accordance with the chart. The other approach is: a series of plan description documents may be formulated to convey planning objectives, which may direct the planner in various phases, but which cannot clearly let him know what conditions should be provided before executing a plan and what effects should be attained after executing the plan. Therefore, a specific implementation approach still needs to be formulated by the planner when executing a plan.

Moreover, the prior art does not teach the planner how to make an e-business plan, so that he often cannot completely consider the business in various aspects from the teaching, and does not direct the planner how to adjust the plan when necessary.

Therefore, solutions according to the prior art have defects: they can not direct the planner to completely and effectively make a plan and to flexibly adjust the plan. In particular, in the e-business field, because it relates to the IT technology and entity business, the planner should completely and carefully make the general plan for the entity e-business, so as to establish a solid and productive business on an e-business platform.

### SUMMARY

An objective of the invention is to provide a system and method for formulating an e-business plan, wherein the system and method can direct the planner to completely consider the technology and business in eight aspects of e-business, and to make an e-business plan based on the internal and outside environments of entity.

Another objective of the invention is to provide a system and method for formulating an e-business plan, wherein the system and method can direct the planner to make an effective action plan in five aspects of “implications analysis”, “execution strategy formulation”, “entry point setting”, “activities”, and “target state setting” step by step when formulating the e-business plan in the aforementioned eight aspects of e-business.

A further objective of the invention is to provide a system and method for formulating an e-business plan, wherein the system and method can direct the planner to check whether the plan is in need of adjustment when executing the plan, and to flexibly adjust the plan when necessary.

In order to fulfill these and other objectives, the invention provides a computer based e-business plan system for directing an entity to formulate an e-business plan, said system comprising the following subsystems: a customer management subsystem executed by the computer to direct the entity to make an e-business plan in the aspect of customer management; an e-business opportunity subsystem executed by the computer to direct the entity to make an e-business plan in the aspect of business opportunity resulting from the e-business; a service management subsystem executed by the computer to direct the entity to make an e-business plan in the aspect of service management; a brand/market management subsystem executed by the computer to direct the entity to make an e-business plan in the aspect of brand/market management; a dynamic content management subsystem executed by the computer to direct the entity to make an e-business plan in the aspect of dynamic content of a web-site; a channel management subsystem executed by the computer to direct the entity to make an e-business plan in the aspect of channel management; an e-business platform subsystem executed by the computer to direct the entity to make an e-business plan in the aspect of e-business transaction; and an internal governance subsystem executed by the computer to direct the entity to make an e-business plan in the aspect of internal governance in e-business environment; wherein said subsystems operate in parallel.

Each subsystem of the computer based e-business planning system in accordance with the invention comprises the following means: an implication analysis means for directing the planner of the entity to analyze the potential impacts and considerations on the entity in terms of resources, organization and operations as a result of e-business action; an execution strategy formulation means for directing the planner to formulate the execution strategy of the subsystem based on said impacts and considerations, wherein the key activities are laid out for implementing the e-business; and a phase plan formulating means for directing the planner to formulate the plan to implement the above execution strategy in phases.

Said phase plan formulating means of the computer based e-business planning system in accordance with the invention further comprises: a target state setting means for directing the planner to set the target state by using the computer, in which said target state is the characteristics of the expected business outcomes in the current phase; an entry point setting means for directing the planner to set the entry point by using the computer, in which said entry point refers to a condition needed to start the execution actions in the current phase; and an activity planning means for directing the planner to set a specific activity plan which leads to the target state.

The computer based e-business planning system in accordance with the invention further comprises a plan adjusting means for checking whether the target state is reached when the specific activity plan is implemented. If not, directing the planner to check whether the specific entry point, target state or activity plan needs to be adjusted. If needed, directing the planner to adjust it; Otherwise, directing the planner to determine whether the execution strategy or the implication analysis needs to be adjusted. If needed, directing the planner to adjust it, and to adjust the specific entry point, target state or activity plan in accordance with the adjusted execution strategy.

In order to fulfill the aforementioned objectives, the invention further provides a computer based e-business planning method for directing an entity to formulate an e-business plan, said method comprising the following steps: a customer management step executed by the computer to direct the entity to make an e-business plan in the aspect of customer management; an e-business opportunity step executed by the computer to direct the entity to make an e-business plan in the aspect of business opportunity resulting from the e-business; a service management step executed by the computer to direct the entity to make an e-business plan in the aspect of service management; a brand/market management step executed by the computer to direct the entity to make an e-business plan in the aspect of brand/market management; a dynamic content management step executed by the computer to direct the entity to make an e-business plan in the aspect of dynamic content of a web-site; a channel management step executed by the computer to direct the entity to make an e-business plan in the aspect of channel management; an e-business platform step executed by the computer to direct the entity to make an e-business plan in the aspect of e-business transaction; and an internal governance step executed by the computer to direct the entity to make an e-business plan in the aspect of internal governance in e-business environment; wherein said steps are executed in parallel.

Each step of the computer based e-business planning method in accordance with the invention comprises the following substeps: an implication analysis substep for directing the planner of the entity to analyze the potential impacts and considerations on the entity in terms of resources, organization and operations as a result of e-business action; an execution strategy formulation substep for directing the planner to formulate the execution strategy of the e-business based on said impacts and considerations, wherein the key activities are laid out for implementing the e-business; and a phase plan formulating substep for directing the planner to formulate the plan to implement the above execution strategy, in phases.

Said phase plan formulating substep of the computer based e-business planning method in accordance with the invention further comprises: a target state setting substep for directing the planner to set the target state by using the computer, in which said target state includes the characteristics of the expected business outcomes in the current phase; an entry point setting substep for the planner to set the entry point by using the computer, in which said entry point refers to a condition needed to start the execution actions in the current phase; and an activity planning substep for directing the planner to set a specific activity plan which leads to the target state.

The computer based e-business planning method in accordance with the invention further comprises a plan adjusting step for checking whether the target state is reached when the specific activity plan is implemented. If not, directing the planner to check whether the specific entry point, target state or activity plan is needed to be adjusted. If needed, directing the planner to adjust it; otherwise, directing the planner to determine whether the execution strategy or the implication analysis needs to be adjusted. If needed, directing the planner to adjust it, and to adjust the specific entry point, target state or activity plan in accordance with the adjusted execution strategy.

Advantages of the invention will be clearer through a detailed description in combination with attached drawings.

### BRIEF DESCRIPTION OF THE DRAWINGS

FIG. 1 is a conceptual block diagram of the e-business planning system according to the invention.

FIG. 2 is a block diagram of subsystems in the system shown in FIG. 1.

FIG. 3 is a flowchart of an execution process of subsystems.

FIG. 4 is a flowchart of the plan adjustment according to the invention.

FIG. 5 is a schedule of execution phase targets of an e-finance plan formulated according to the invention.

FIGS. 6-13 are the plan documents in the phase 0 of a typical e-business plan according to the invention.

### DETAILED DESCRIPTION

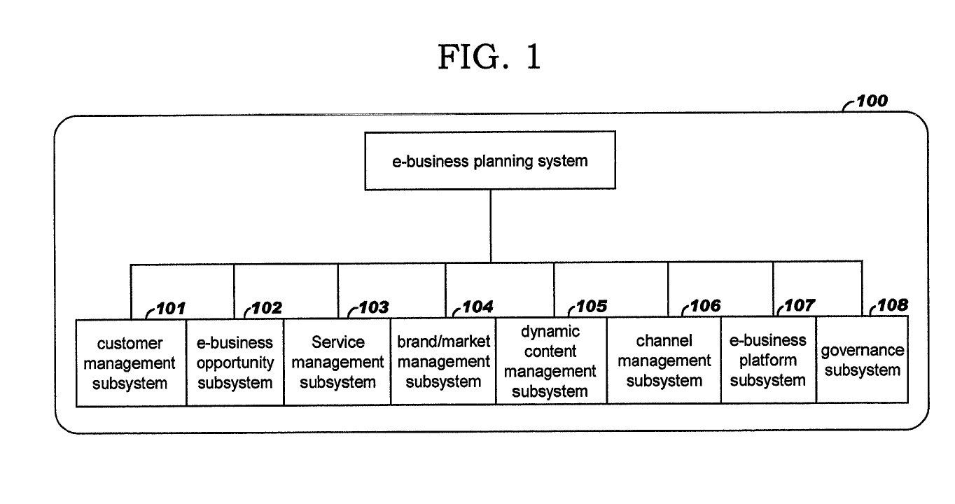

FIG. 1 is a conceptual block diagram of the e-business planning system according to the invention. As shown in FIG. 1, the e-business planning system 100 of the invention comprises eight subsystems 101-108. The e-business plan can be formulated by the planner in terms of the eight subsystems, and can completely consider the internal and external environments of the entity. The eight subsystems are as follows.

A customer management subsystem 101: when an entity wants to be successful in e-business, the customer information must be treated as a valuable resource, and it will get a better return if the e-business provides a good service to the customer. Therefore, customer management must be sufficiently considered in the process of establishing the e-business, because the business departments within the entity can then use respective advantages and attain the benefits through e-business. Thus, the system according to the invention uses the customer management as a subsystem for directing the planner to formulate the e-business plan.

An e-business opportunity subsystem 102: when an entity such as an enterprise uses an e-business for transaction, the operation mode, organization and scope of services of business departments within the entity will be influenced by the e-business opportunity introduced by an enterprise portal site. Thus, when planning the e-business of the entity, through formulating the plan in consideration of e-business opportunity, the entity can know the definite requirements of customers and develop its potential target customers.

A service management subsystem 103: under the business environment of e-business, the entity's and employee's operational capability will be reformed by providing customers with a standardized online service. Thus, the service level of the entity will be improved by planning the entity e-business in terms of service management.

A brand/market management subsystem 104: under the business environment of e-business, an entity may wish to establish a single brand from a plurality of brands of the existing service lines offering different products, because the single brand may represent the competitive advantages of the entity as a whole. Thus, the brand/market management will effectively make the brand be accepted and famous in the local area, even in the whole world.

A dynamic content management subsystem 105: under the business environment of e-business, the dynamic content management of enterprise portal sites is an active appearance and store front of an entity, and the contents result from efforts of the business departments in applying the contents creation tools efficiently. Thus, when the e-business is created from the aspect of a dynamic content management, the entity can present the customers with a new appearance.

A channel management subsystem 106: a good channel for providing the target customers with content rich products and services is a strong tool to engender prosperity, and will ensure that business departments provide the special customer group with better service. Thus, when formulating and executing the e-business plan in the aspect of channel management, the entity can improve its channel management capability, and can gain competitive advantages from economy of scale.

An e-business platform subsystem 107: the e-business platform may serve all the business departments, and meet future business needs in combination with the whole e-business scheme and technology. Thus, when creating an e-business in the aspect of e-business platform, the e-business will provide the entity with sufficient support from the technical infrastructure.

A governance subsystem 108: to execute the e-business smoothly, a cooperative governance structure is needed, and an e-business governance scheme based on the current business management is needed by the enterprise portal.

The system of the invention can direct the planner to formulate a plan in eight aspects of subsystems. A process for formulating an e-business plan in terms of subsystems of the invention will be described in detail as follows.

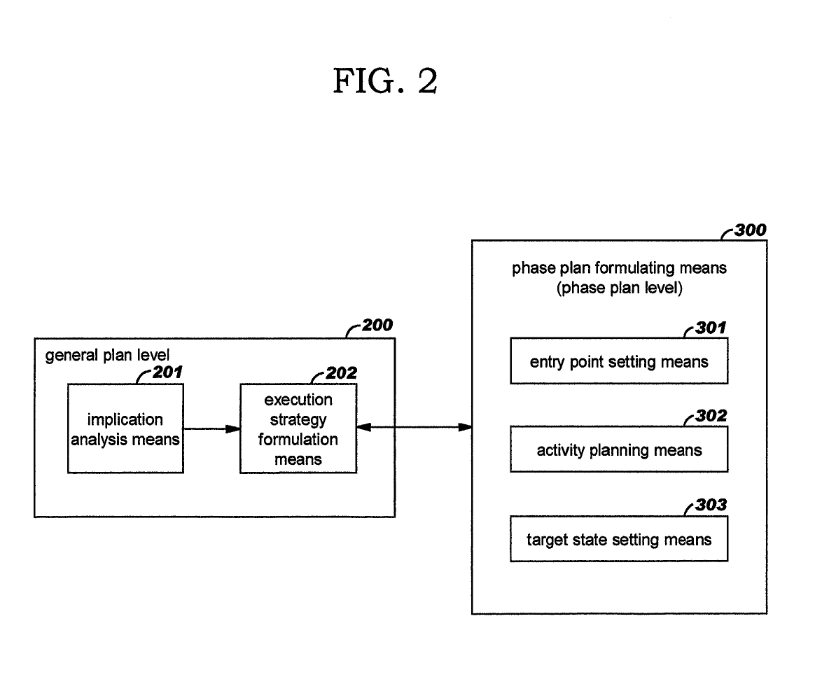

FIG. 2 is a block diagram of formulating an e-business in terms of subsystems of the invention. As shown in FIG. 2, when directing the planner to formulate an e-business plan, subsystems can be performed in two levels, i.e., a general plan level 200 and a phase plan level executed by phase plan formulating means 300.

The general plan level 200 comprises an implication analysis means 201 and an execution strategy formulation means 202.

The implication analysis means 201 will direct the entity leader level, business departments, and e-business departments being established to analyze the potential impacts and considerations on the entity departments in terms of resources, organization and operations as a result of e-business action. For example, in the customer management subsystem, the implication analysis means 201 will direct the entity leader level, business departments, and e-business departments to analyze the potential impacts and considerations on the entity departments in the aspect of the customer management as the result of e-business action.

The execution strategy formulation means 202 will direct the planner to formulate the execution strategy based on the analysis results output from the implication analysis means 201; in particular, in the light of the potential impacts and considerations output from the implication analysis means 201, the planner will find out the solution, complete the expected work, and create the conditions for the following execution phases. Moreover, the execution strategy formulation means 202 will direct the planner to lay out the key tasks for creating the e-business in the aspect of this subsystem. Up to now, subsystems in the general plan-level 200 have completed their work.

Then, entering the phase plan level. In this level, the phase plan formulating means 300 directs the planner to divide the execution process into several phases for formulating step by step the activity plan of execution strategy and to formulate the targets to be fulfilled in respective phases, wherein the phase plans are dependent on the execution strategy. In each of the particular phases, the phase plan formulating means 300 further directs the planner to formulate the specific activity plan through using an entry point setting means 301, an activity planning means 302 and a target state setting means 303; wherein the target state setting means 303 prompts the planner to set the characteristics of the expected business outcomes in the current phase in accordance with the targets to be fulfilled in the respective phase. The entry point setting means 301 prompts the planner to set the conditions for starting the present phase activities in accordance with the targets of the phase. The activity planning means 302 prompts the planner to set the activities to reach the target state.

With subsystems shown in FIG. 2, the invention can direct the planner to step by step formulate an activity plan from the high level to the detailed phases; and can make the planner definitely know the effects to be fulfilled in respective phases and set the activity measures to be taken for fulfilling these effects, through clearly laying out the conditions required by starting respective phase execution and the target state of the phase.

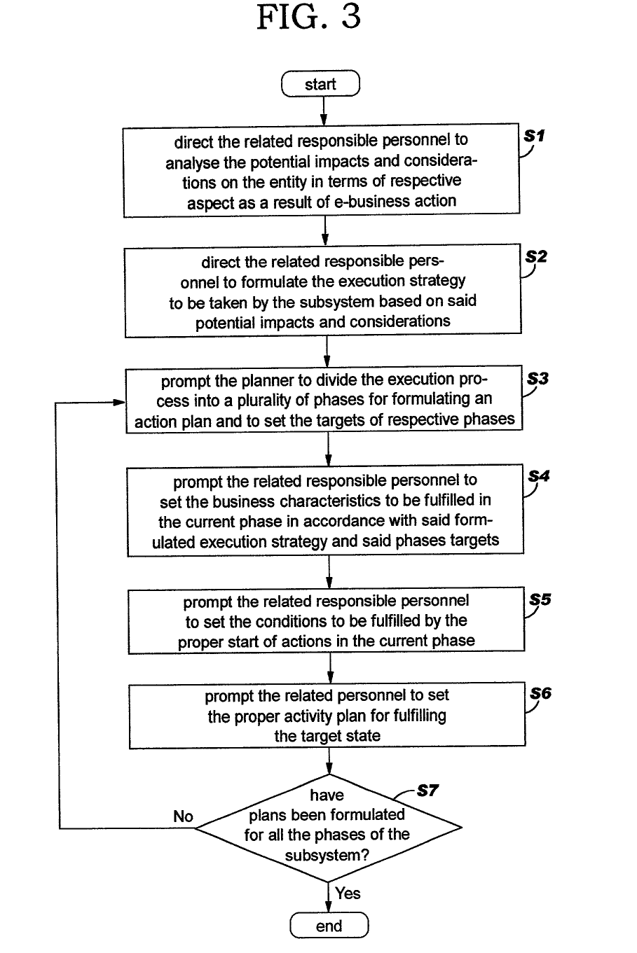

A process for formulating the e-business plan according to the invention method will be described with reference to FIG. 3 as follows. As shown in FIG. 3, when formulating an e-business plan, firstly in step S1, the implication analysis means 201 directs the related planner to analyze the potential impacts and considerations on the entity in terms of respective aspect as a result of e-business action. Secondly in step S2, the execution strategy formulation means 202 directs the related planner to formulate the execution strategy to be taken by itself based on said potential impacts and considerations. In step S3, the phase plan formulating means 300 directs the planner to divide the execution process into a plurality of phases for formulating an activity plan and to set the targets of respective phases. Steps S4-S7 are the steps executed in the plan formulation process of respective phases. In step S4, the target state setting means 303 prompts the related planner to set the business characteristics to be fulfilled in the current phase in accordance with said formulated execution strategy and said phase targets. In step S5, the entry point setting means 301 prompts the related planner to set the conditions to be fulfilled by the proper start of activities in the current phase. In step S6, the activity planning means 302 prompts the related personnel to set the proper activity plan for fulfilling the target state. Then, passing to step S7, the planner judges whether activity plans are formulated for all the execution phases. If there is an execution phase for which an activity plan is not formulated, then the system returns to step S3 for executing steps S3-S5 to formulate the activity plan of the next phase. When it is judged in step S7 that activity plans have been formulated for all the execution phases, the planning process of the present subsystem is ended.

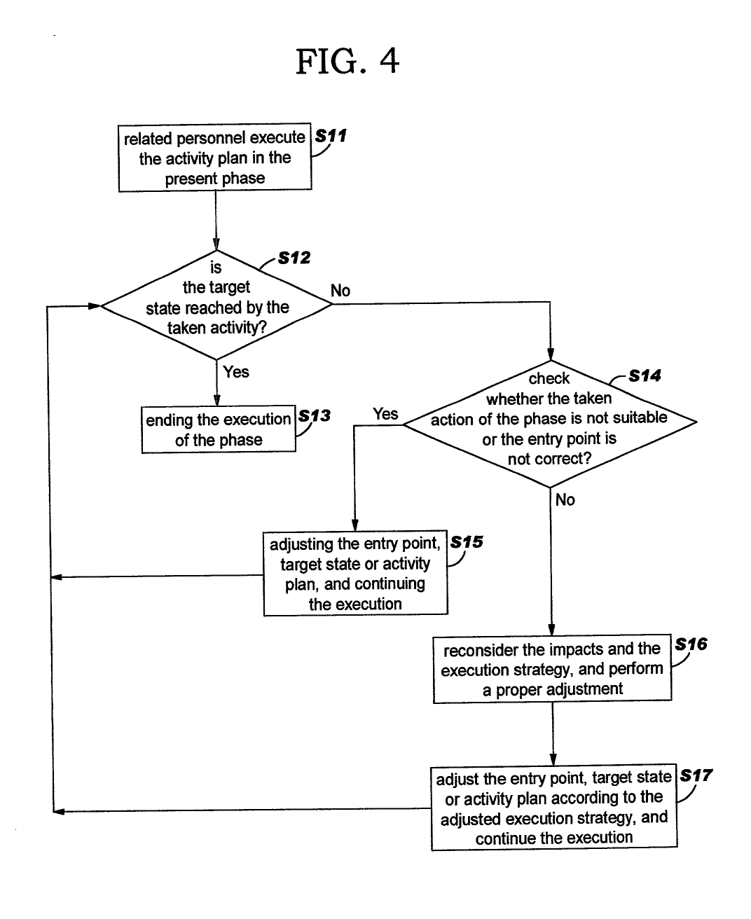

Up to now, the process for formulating the e-business plan according to the system and method of the invention has been described with reference to FIG. 3. Moreover, in the process of executing the formulated plan, it can be checked according to the invention whether the execution status corresponds to the plan; and when the plan is not suitable, the invention can direct the related responsible personnel to adjust the plan. Therefore, when executing the plan, the plan can be flexibly adjusted according to the execution status, and the formulation can correspond to the practical status. The invention fulfills said functions through providing a plan adjusting means (not shown). The process for adjusting the plan through the plan adjusting means according to the invention will be described with reference to FIG. 4 as follows.

As shown in FIG. 4, in the execution processes of respective phases, in step S11, the related personnel execute the activity plan of the present phase. In step S12, it is judged whether the target state is reached by the taken activity. When it is judged in step S12 that the taken activity does not reach the target state expected in the current phase, the subsystem passes to step S14, and prompts related responsible personnel to check whether there is an unsuitable place in the process of executing steps S3, S4 and S5 shown in FIG. 3. If there is an unsuitable place to be adjusted in the phase, then the subsystem passes to step S15 for adjusting the entry point, target state or activity plan which is set in the phase, and for executing the adjusted activity. Then, the subsystem returns to step S12 for further judgment. Moreover, if it is judged in step S14 that the phase does not have any unsuitable activity and the set entry point and target state are correct, then the subsystem passes to step S16 for prompting related responsible personnel to reconsider the potential impacts or execution strategy, and to adjust them when necessary. Then in step S17, the entry point, target state or activity plan being executed in the phase is adjusted according to the adjusted execution strategy, and the execution activity is continued according to the adjusted activity or target state. Then, the subsystem returns to step S12 for further judgment.

The plan can be flexibly adjusted by executing the plan adjustment functions.

When formulating the e-business plan according to the invention, the eight subsystems are conducted at the same time, and can be compared with and cooperated with each other, so as to direct the planner to formulate an overall plan.

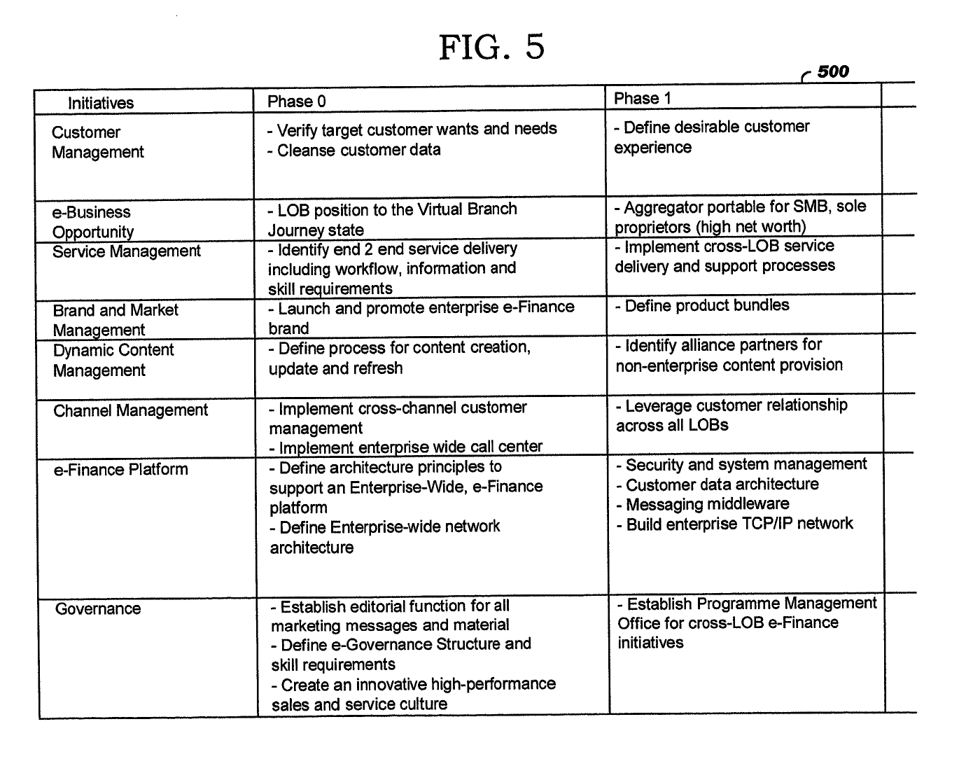

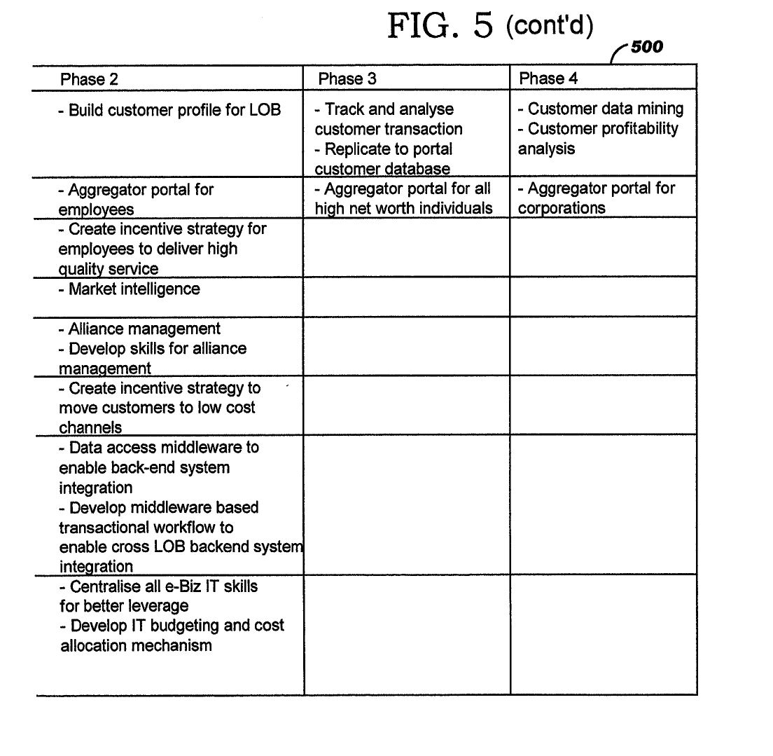

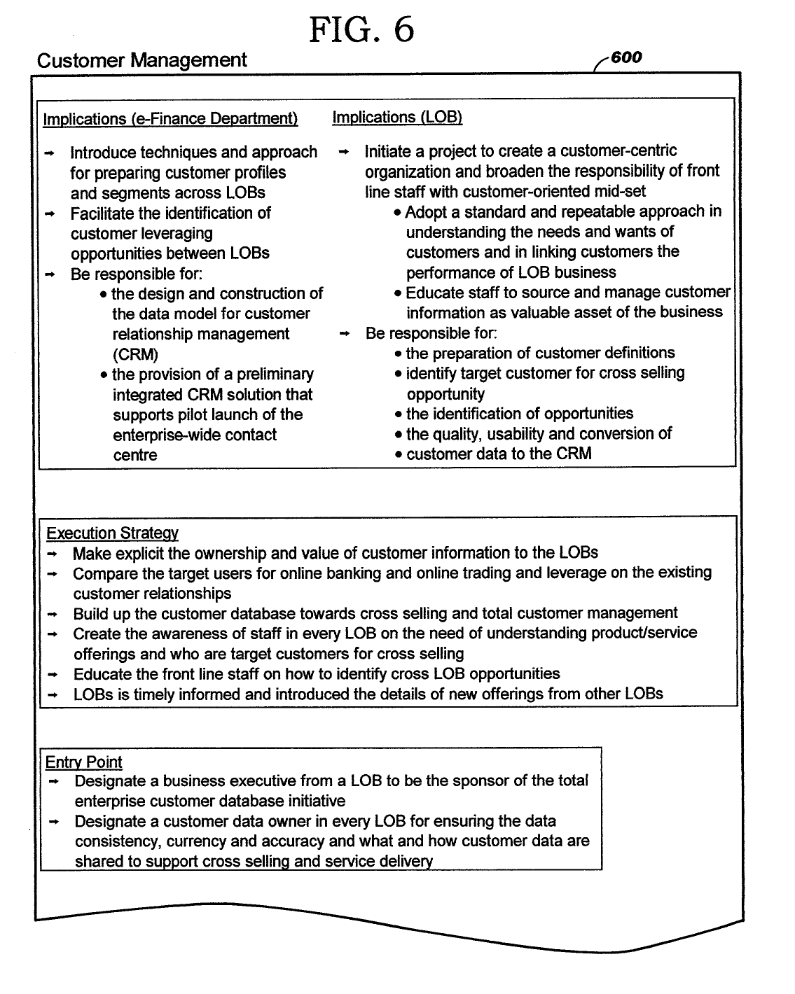

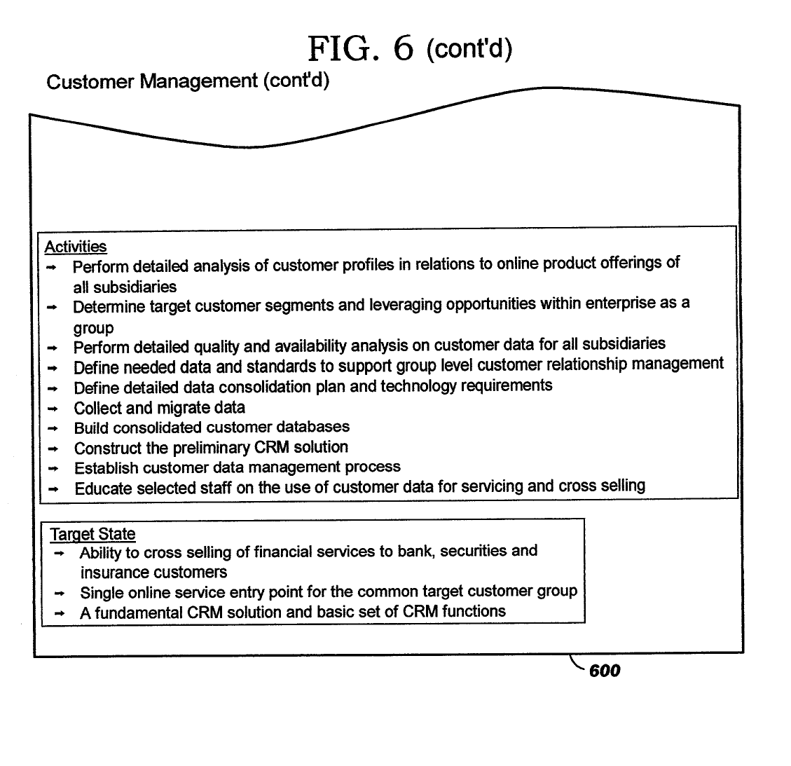

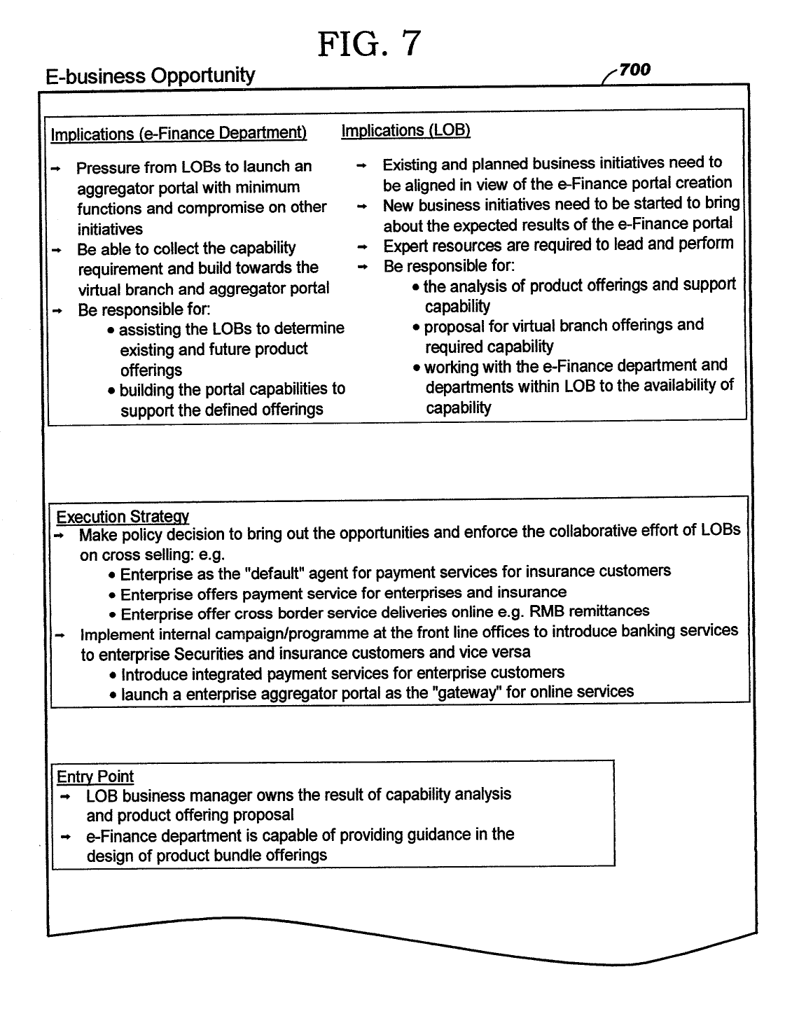

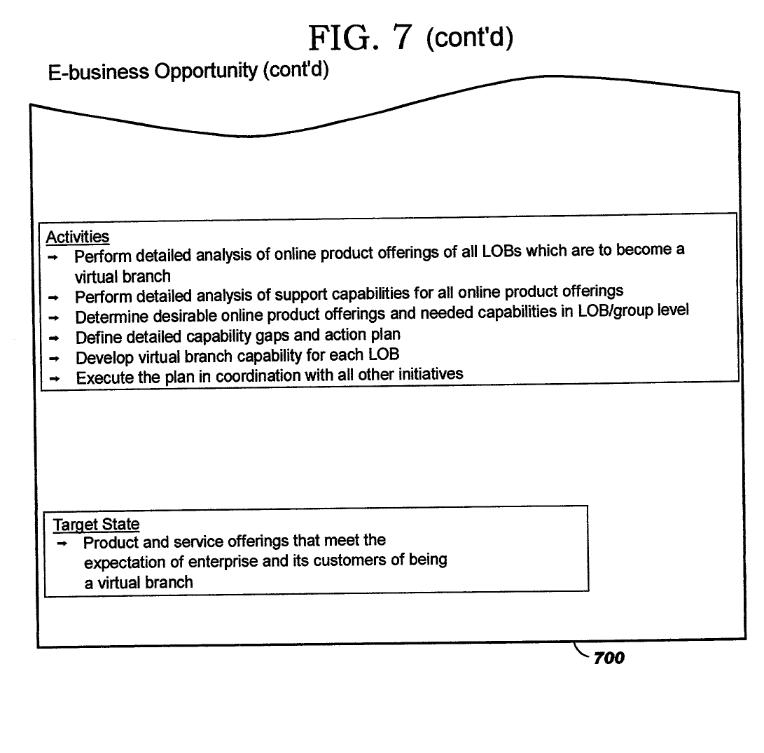

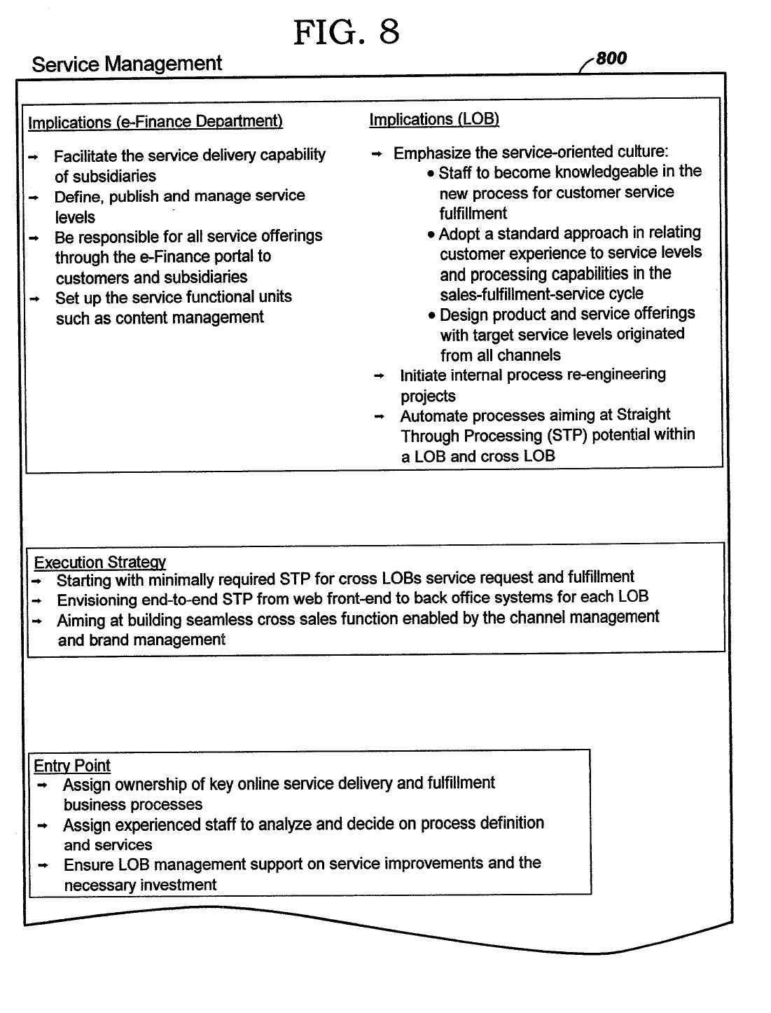

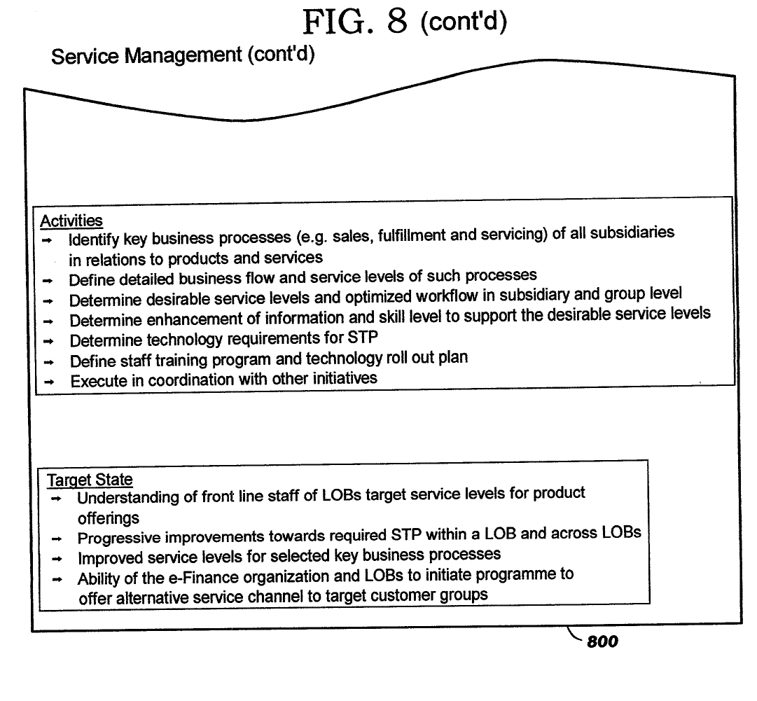

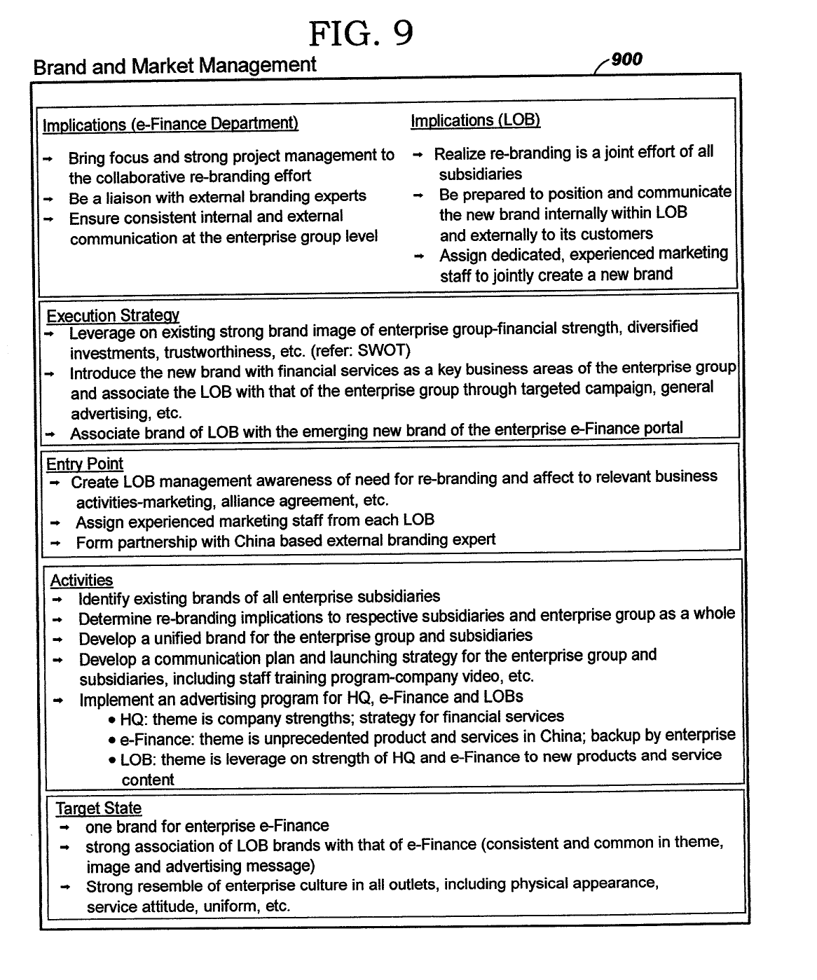

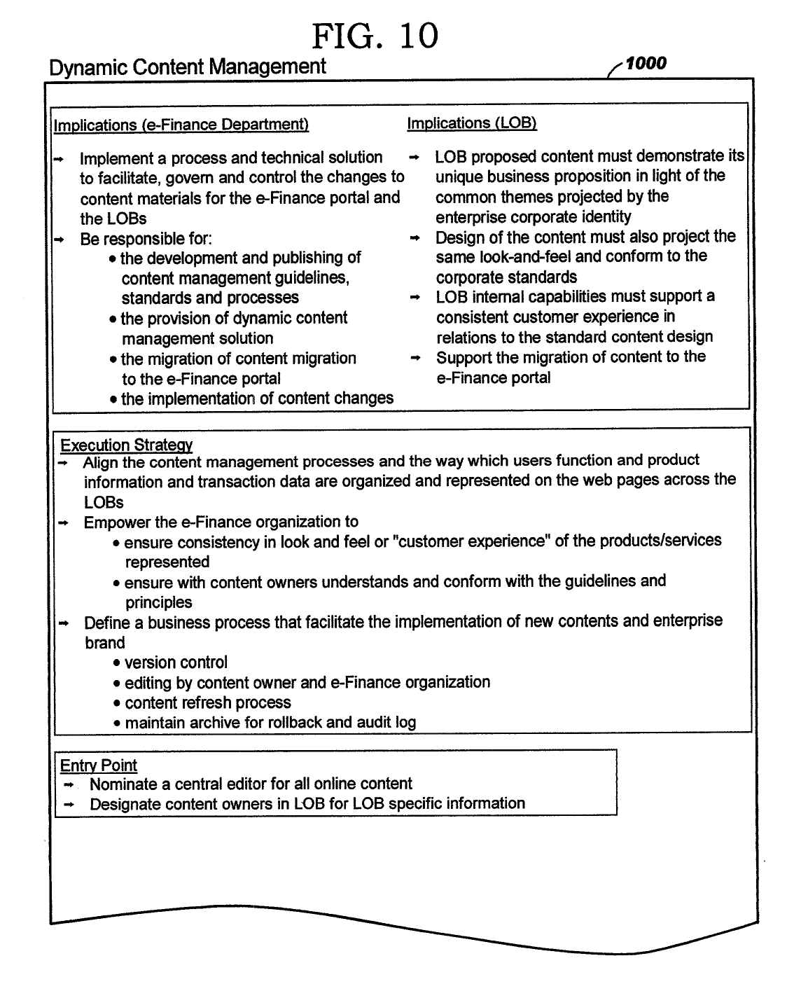

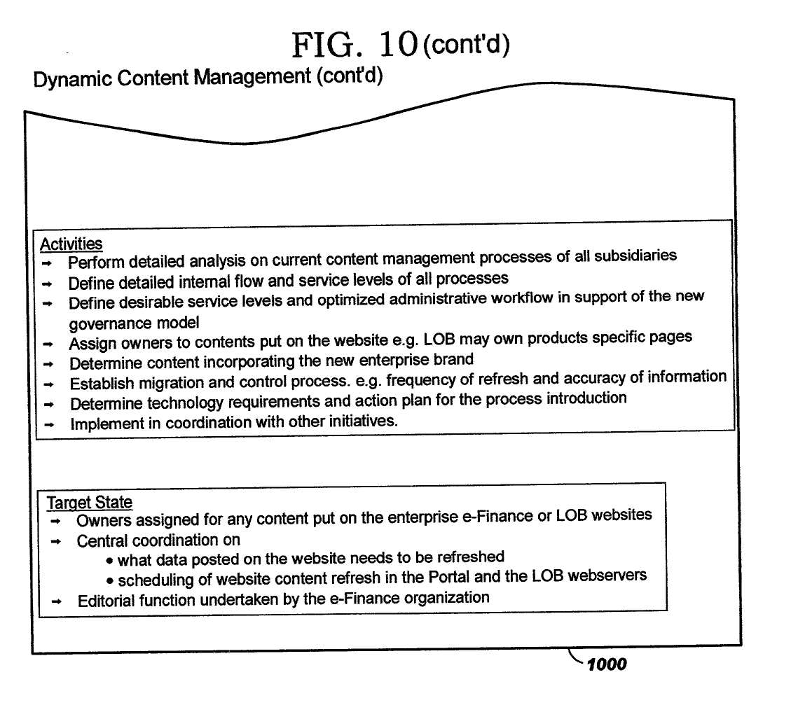

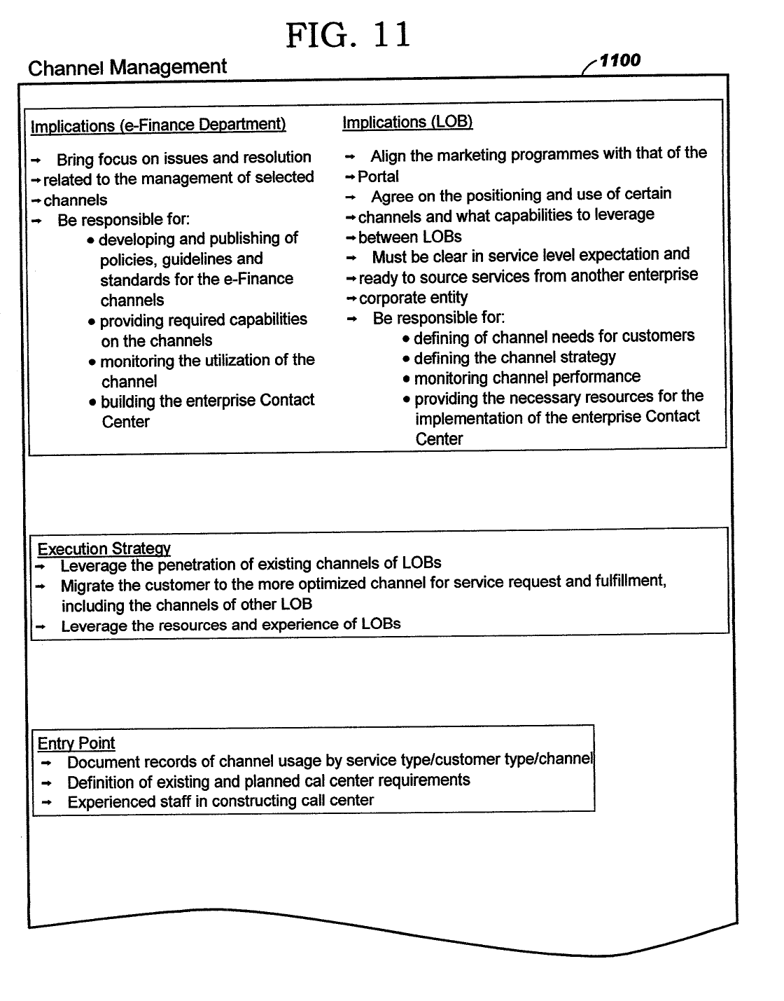

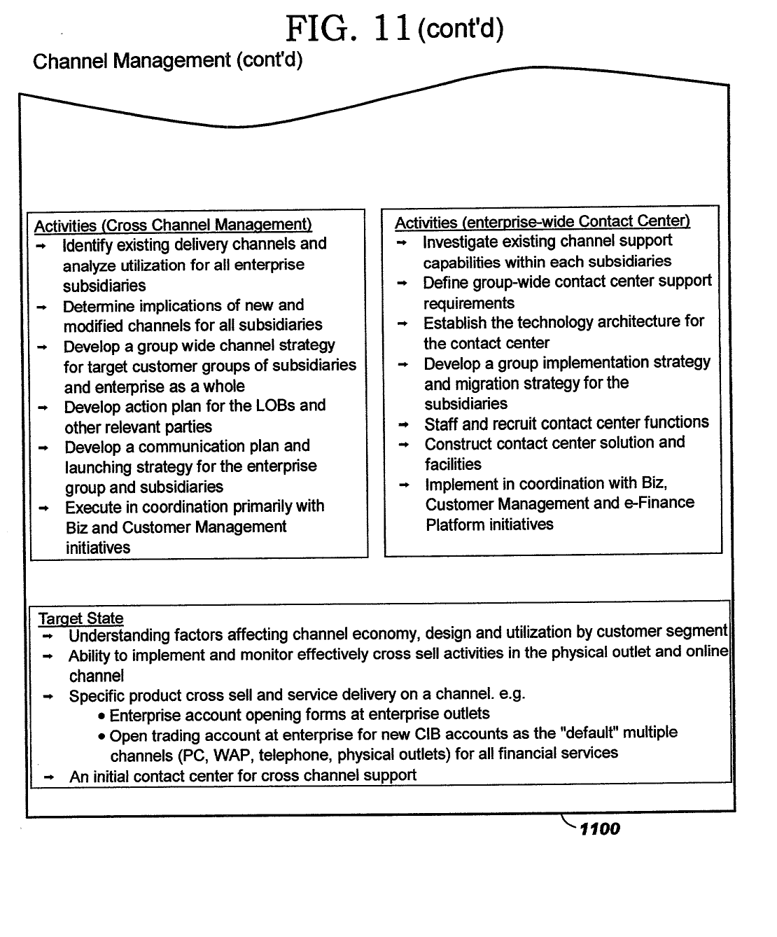

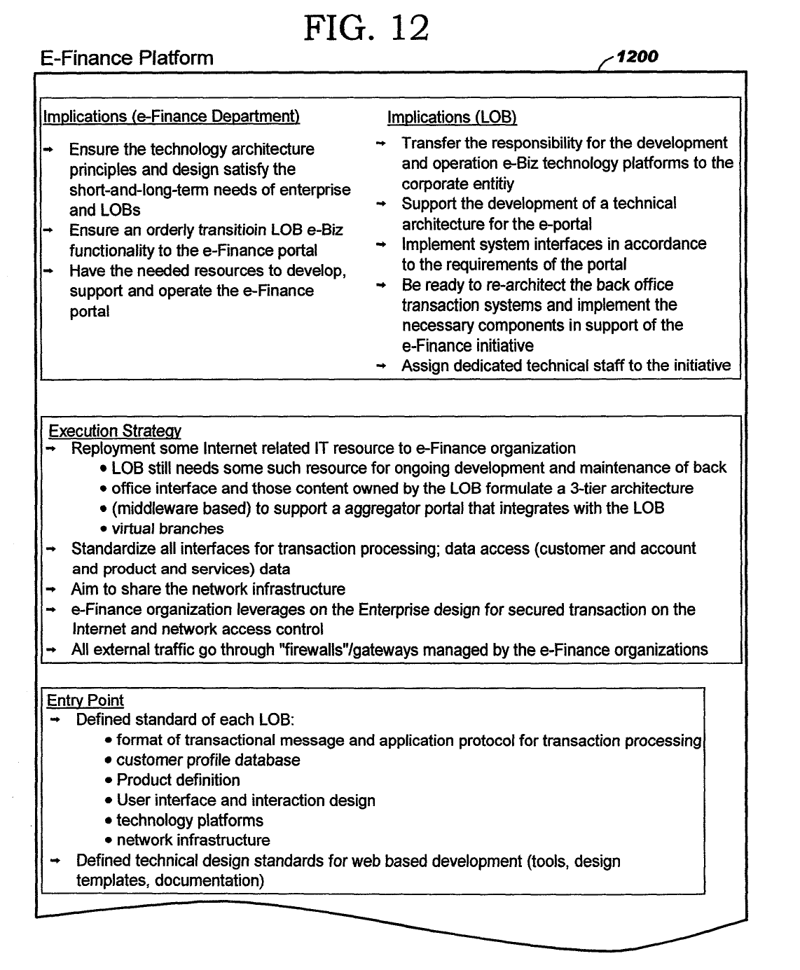

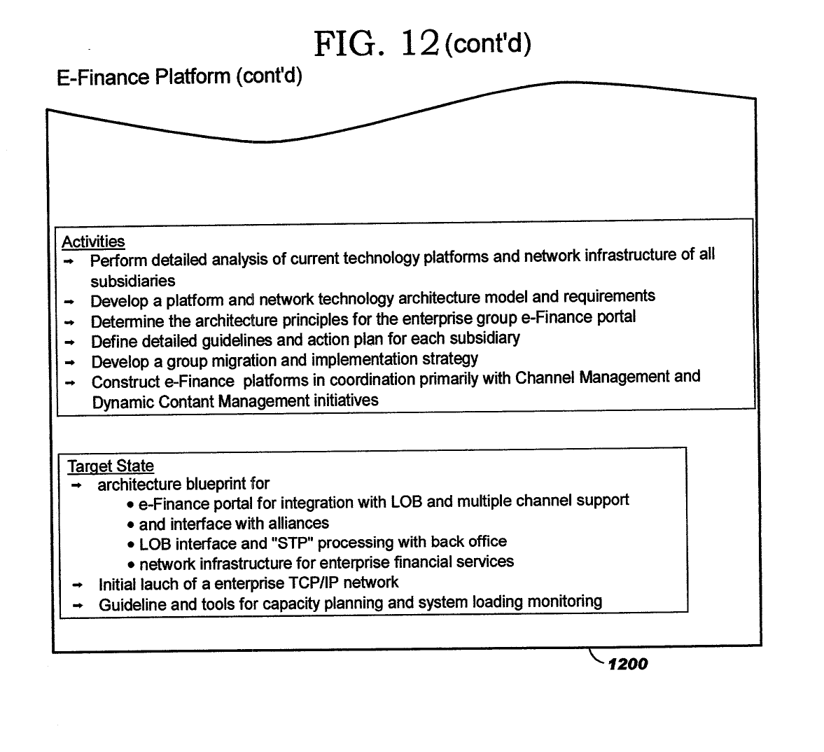

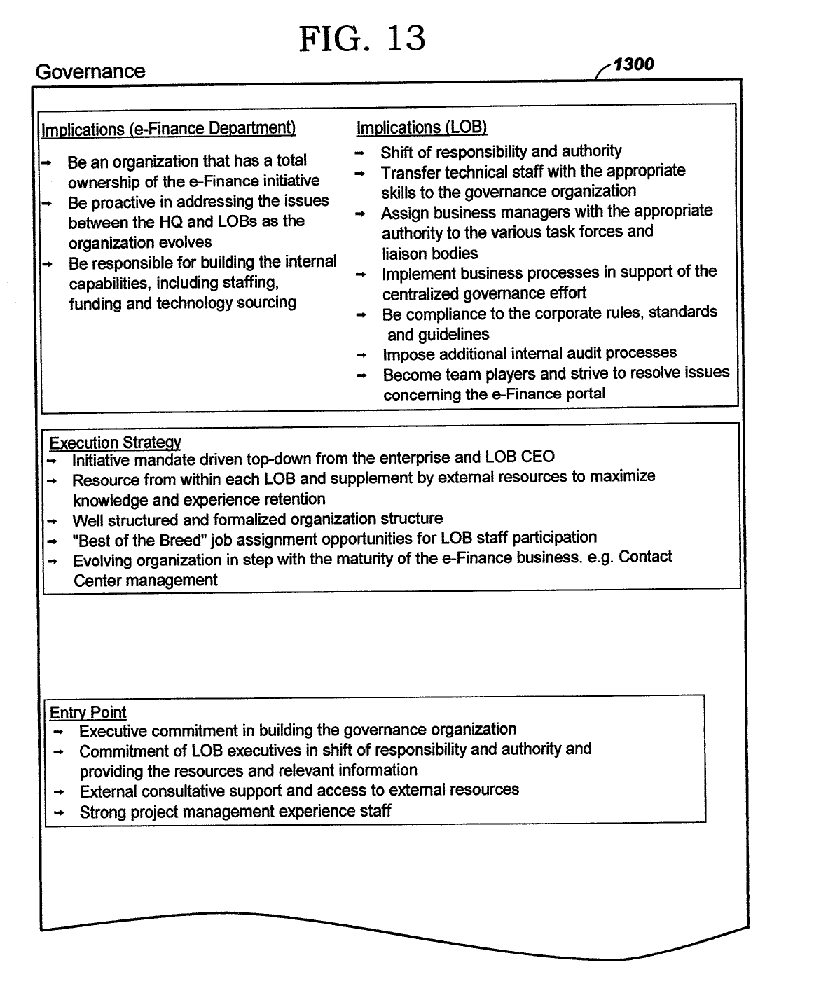

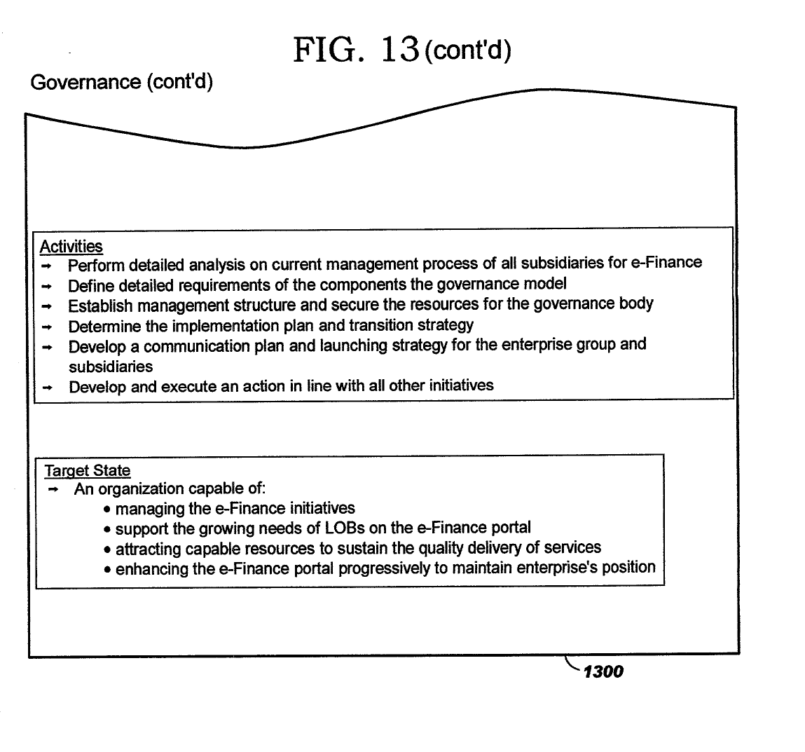

FIGS. 5-13, by way of example, show a part of a plan document which is formulated by an entity that will create an e-finance according to the system and method of the invention, wherein the entity divides the e-finance plan into eight items which are respectively formulated under the direction of eight subsystems of the invention. FIG. 5 is a schedule 500 of execution phase targets of an e-finance plan formulated under the direction of the invention. FIGS. 6-13 are the plan documents 600-1300 in the execution phase 0 under the direction of subsystems of the invention. Those skilled in the art also can formulate the plan documents of phases 1-5 under the direction of the invention, once taught the present invention.

The invention can direct the entity to formulate the e-business plan in terms of eight subsystems, and the plan can be formulated in each subsystem according to the method of the invention. Thus, the invention can help the entity to formulate a plan document which adapts to the internal and external environments of the entity.

Those skilled in the art will understand that the computer based e-business planning system and method of the invention can direct the planner to formulate or adjust the plan through an operation of a server in network or of a customer computer, and can be realized through a combination operation of the server with the computer according to the entity status. Of course, a single personal computer also can fulfill the system and method of the invention. Moreover, the planners in the invention may be either different persons or the same person.

Furthermore, devices and steps for storing and displaying the formulated plan document are not shown in the specification and drawings, but it will be known by those skilled in the art that each subsystem of the invention may have one or more storage devices for storing the data those results from each means of the general and phase plan levels. Each subsystem may have a display device for displaying the storage contents to customers.

The invention has been described in detail according to specific embodiments and drawings, but it is not limited by the description. The invention can be amended and improved without departing from the spirit and scope of the invention.

We claim:

1. A computer based e-business planning system for directing an entity to formulate an e-business plan, comprising:
a customer management sub-system, executed by the computer to direct the entity to include a customer management aspect in an e-business plan;
an e-business opportunity sub-system, executed by the computer to direct the entity to include a business opportunity aspect in the e-business plan;
a service management sub-system, executed by the computer to direct the entity to include a service management aspect in the e-business plan;
a brand/market management sub-system, executed by the computer to direct the entity to include a brand/market management aspect in the e-business plan;
a dynamic content management sub-system, executed by the computer to direct the entity to include a dynamic web site content aspect in the e-business plan;
a channel management sub-system, executed by the computer to direct the entity to include a channel management aspect in the e-business plan;
an e-business platform sub-system, executed by the computer to direct the entity to include an e-business transaction aspect in the e-business plan; and
a governance sub-system, executed by the computer to direct the entity to include an internal governance aspect in the e-business plan; wherein the sub-systems operate in parallel.

2. The system according to claim 1, wherein each of the sub-systems comprises:
implications analysis means, for directing a planner of the entity to analyze potential impacts and considerations to the entity in terms of resources, organization and operations as a result of e-business action;
execution strategy formulation means, for directing the planner to formulate an execution strategy based on implications generated by the implications analysis means, and lay out key activities for implementing the e-business;
phase-plans formulating means, for directing the planner to formulate plans to implement the execution strategy in phases.

3. The system according to claim 2, wherein, the phase-plans formulating means further comprises:
target state setting means, for directing the planner to set a target state by using the computer, in which the target state includes characteristics of expected business outcomes in a current phase;
entry point setting means, for directing the planner to set an entry point by using the computer, in which said entry point includes key project elements to ensure a proper start of actions in the current phase;
activities planning means, for directing the planner to set activities which lead to the target state.

4. The system according to claim 3, further including a plan adjusting means, for checking whether or not the target state is reached when the activities have been implemented, and if not, directing the planner to check whether or not the entry point, the activities or the target state needed to be adjusted, and if needed, directing the planner to make an adjustment else directing the planner to determine whether or not the execution strategy needs to be adjusted, and if needed, directing the planner to make an adjustment, and to adjust the entry point, the activities and the target state according the adjusted execution strategy.

5. A computer based e-business planning method for directing an entity to formulate an e-business strategy and implementation plan, comprising:
a customer management step, executed by the computer to direct the entity to include an aspect of customer management in an e-business plan;
an e-business opportunity step, executed by the computer to direct the entity to include an aspect of business opportunity resulting from the e-business in the e-business plan;
a service management step, executed by the computer to direct the entity to include an aspect of service management in the e-business plan;
a brand/market management step, executed by the computer to direct the entity to include an aspect of brand/market management in the e-business plan;
a dynamic content management step, executed by the computer to direct the entity to include an aspect of dynamic content of a web-site in the e-business plan;
a channel management step, executed by the computer to direct the entity to include an aspect of channel management in the e-business plan;
an e-business platform step, executed by the computer to direct the entity to include an aspect of e-business transaction in the e-business plan; and
a governance step, executed by the computer to direct the entity to include an aspect of internal governance in e-business environment in the e-business plan; wherein the
steps operate in parallel.

6. The method according to claim 5, wherein each step further comprises:
an implication analysis sub-step, for directing a planner of the entity to analyze the potential impacts and considerations to the entity in terms of resources, organization and operations as a result of e-business action;
an execution strategy formulation sub-step, for directing the planner to formulate an execution strategy based on implications generated by the implications analysis sub-step, and lay out key activities for implementing the e-business; and
a phase-plans formulating step, for directing the planner to formulate plans to implement the execution strategy in phases.

7. The system according to claim 6, wherein, the phase-plans formulating the sub-step, further comprises:
a target state setting sub-step, for directing the planner to set a target state by using the computer, in which the target state includes characteristics of expected business outcomes in a current phase;
an entry point setting sub-step, for directing the planner to set an entry point by using the computer, in which the entry point includes key project elements to ensure a proper start of actions in the current phase;
an activity planning sub-step, for directing the planner to set activities which lead to the target state.

8. The system according to claim 7, further including a plan adjusting step, for checking whether or not the target state is reached when the activities have been implemented, and if not, directing the planner to check whether or not the entry point, the activities or the target state needed to be adjusted, and if needed, directing the planner to make an adjustment else directing the planner to determine whether or not the execution strategy needs to be adjusted, and if needed, directing the planner to adjust the execution strategy, and to adjust the entry point, the activities and the target state according to the adjusted execution strategy.
